(19) United States
(12) Patent Application Publication
(10) Pub. No.: US 2013/0050065 A1
(43) Pub. Date: Feb. 28, 2013

(54) HEAD-MOUNTED DISPLAY, AND DISPLAY CONTROL METHOD

(71) Applicant: Masayuki Shimizu, Kanagawa (JP)

(72) Inventor: Masayuki Shimizu, Kanagawa (JP)

(73) Assignee: SONY CORPORATION, Tokyo (JP)

(21) Appl. No.: 13/584,030

(22) Filed: Aug. 13, 2012

(30) Foreign Application Priority Data
Aug. 30, 2011 (JP) 2011-187978

(51) Int. Cl. G09G 5/00

(52) U.S. Cl. 345/8

(57) ABSTRACT

A head-mounted display includes a left-eye display section to display a left-eye image, a right-eye display section to display a right-eye image, and a display control section to exert control over screen display of the right- and left-eye display sections. For checking whether adjustment over screen positions of the right- and left-eye display sections is correctly made, the display control section displays a combination of a first and second normal display check screens by the right- and left-eye display sections, the first normal display check screen including a lateral line extending in a horizontal direction at a screen center, the second normal display check screen including a plurality of short vertical lines aligned in the horizontal direction at the screen center, and the display control section provides an enhancement section to each of upper and lower ends of each of the vertical lines on the second normal display check screen.

### CROSS-REFERENCE TO RELATED APPLICATION

The present application claims priority from Japanese Patent Application No. JP 2011-187978 filed in the Japanese Patent Office on Aug. 30, 2011, the entire content of which is incorporated herein by reference.

### BACKGROUND

The present disclosure relates to a head-mounted display for use with viewing of video by being worn on the head of a user, and to a display control method, and more specifically, to a head-mounted display allowing the user to check whether or not right and left display sections are each correctly adjusted in screen position, and to a display control method.

A display unit, i.e., head-mounted display (HMD), has been well known for viewing of video by being worn on the head of a user. The head-mounted display is configured to control senses of vision and hearing by including an optical unit for each of the right and left eyes of the user, and by being used with a headphone. If the head-mounted display is so configured as to completely shut out the outside world when the user wears the head-mounted display, the user feels more the virtual reality environments at the time of viewing of video. The head-mounted display is capable of performing video display differently to the right and left eyes, and if the parallax images are displayed to the right and left eyes, the user accordingly sees 3D images.

The head-mounted display is a display system offering virtual images to the user, i.e., forming virtual images on the user's eyes' retinas. Herein, the virtual images are formed on the side of an object when the object is positioned closer to a lens considering the focal length. For providing the user with the virtual images, for example, the distance from the user where the virtual images are formed is desirably changed depending on the video. As an example, Japanese Patent Application Laid-open No. 2007-133415 (hereinafter, referred to as Patent Document 1) describes a display unit of providing virtual images suitably depending on the video. This display unit is provided with a magnification optical system that disposes the same virtual image viewed by the user's right and left eyes on the same plane. The display unit uses the aspect ratio of the video as a basis to control the distance of the virtual image from the user, and the size of the virtual image.

The head-mounted display may have display sections for right and left eyes each being a high-resolution display panel including liquid crystal elements or organic EL (Electro-Luminescence) elements, for example. Moreover, the more realistic effects are to be produced to make the user feel as if being in a movie theater by using the optical system to set an appropriate angle of view, and by using a headphone for multichannel sound reproduction. Before shipment of the head-mounted display, the manufacturer/distributor thereof generally adjusts the right and left display sections in screen position to allow suitable image fusion between right and left video in the user's brain by virtual images being formed on the user's eyes' retinas with a desired angle of view and sense of depth. However, after the purchase by the user, the screen positions of the right and left display sections having been adjusted as such may be displaced on impact during the use.

If the user keeps using the head-mounted display with the right and left display sections whose screen positions are not appropriate, the user's eyes may get tired easily, and may cause health damage. In such a case, the user is expected to immediately stop using the head-mounted display, and to make an inquiry to the manufacturer or ask them for a repair. If the user does not appropriately stop the use of the head-mounted display, the manufacturer consequently has complaints from the user.

### SUMMARY

It is thus desirable to provide an excellent head-mounted display that allows a user to suitably check whether or not the right and left display sections are correctly adjusted in screen position, and a display control method.

A head-mounted display according to a first embodiment of the present disclosure includes a left-eye display section configured to display a left-eye image, a right-eye display section configured to display a right-eye image, and a display control section configured to exert control over screen display of the right- and left-eye display sections. In the head-mounted display, for checking whether or not adjustment over screen positions of the right- and left-eye display sections is correctly made, the display control section displays a combination of a first normal display check screen and a second normal display check screen by the right- and left-eye display sections, the first normal display check screen including a lateral line extending in the horizontal direction at the screen center, the second normal display check screen including a plurality of short vertical lines aligned in the horizontal direction at the screen center, and the display control section provides an enhancement section to each of upper and lower ends of each of the vertical lines on the second normal display check screen.

According to a second embodiment of the present disclosure, in the head-mounted display of the first embodiment, the enhancement section is a short lateral line to be rendered at each of the upper and lower ends of each of the vertical lines on the second normal display check screen.

According to a third embodiment of the present disclosure, in the head-mounted display of the first embodiment, at startup of the head-mounted display, the display control section displays the combination of the first and second normal display check screens by the right- and left-eye display sections.

According to a fourth embodiment of the present disclosure, the head-mounted display of the first embodiment is further provided with a pupillary-distance adjustment mechanism configured to adjust a pupillary distance between the right- and left-eye display sections. For adjustment of the pupillary distance by the pupillary-distance adjustment mechanism, the display control section displays a pupillary-distance adjustment screen by the right- and left-eye display sections, the pupillary-distance adjustment screen including a character string substantially at the screen center.

According to a fifth embodiment of the present disclosure, the head-mounted display of the first embodiment is further provided with a pupillary-distance adjustment mechanism configured to adjust a pupillary distance between the right- and left-eye display sections. At startup of the head-mounted display, the display control section displays a startup screen by the right- and left-eye display sections, the startup screen including a character string substantially at the screen center for use of adjustment of the pupillary distance by the pupillary-distance adjustment mechanism.

A display control method for a head-mounted display according to a sixth embodiment of the present disclosure includes displaying, for checking whether or not adjustment over a screen position of the head-mounted display is correctly made, a combination of a first normal display check screen and a second normal display check screen by a right-eye display section and a left-eye display section, the first normal display check screen including a lateral line extending in the horizontal direction at the screen center, the second normal display check screen including a plurality of short vertical lines aligned in the horizontal direction at the screen center. In the displaying, an enhancement section is provided to each of upper and lower ends of each of the vertical lines on the second normal display check screen.

According to a seventh embodiment of the present disclosure, in the display control method of the sixth embodiment, in the displaying, the enhancement section being a short lateral line is rendered at each of the upper and lower ends of each of the vertical lines on the second normal display check screen.

According to an eighth embodiment of the present disclosure, in the display control method of the sixth embodiment, in the displaying, at startup of the head-mounted display, the combination of the first and second normal display check screens are displayed on the right- and left-eye display sections.

According to a ninth embodiment of the present disclosure, the head-mounted display is further provided with a pupillary-distance adjustment mechanism configured to adjust a pupillary distance between the right- and left-eye display sections. The display control method of the sixth embodiment is further provided with displaying, for adjustment of the pupillary distance by the pupillary-distance adjustment mechanism, a pupillary-distance adjustment screen by the right- and left-eye display sections, the pupillary-distance adjustment screen including a character string substantially at the screen center.

According to a tenth embodiment of the present disclosure, the head-mounted display is further provided with a pupillary-distance adjustment mechanism configured to adjust a pupillary distance between the right- and left-eye display sections. The display control method of the sixth embodiment is further provided with displaying, at startup of the head-mounted display, a startup screen by the right- and left-eye display sections, the startup screen including a character string substantially at the screen center for use of adjustment of the pupillary distance by the pupillary-distance adjustment mechanism.

According to the present disclosure, there are provided an excellent head-mounted display with which a user is allowed to suitably check whether or not right and left display sections are each correctly adjusted in screen position, and a display control method.

These and other objects, features and advantages of the present disclosure will become more apparent in light of the following detailed description of best mode embodiments thereof, as illustrated in the accompanying drawings.

### BRIEF DESCRIPTION OF DRAWINGS

FIG. 1 is a diagram schematically showing the configuration of an image display system including a head-mounted display;

FIG. 2 is a diagram schematically showing the internal configuration of the heat-mounted display;

FIG. 3 is a bird's eye view showing the upper surface of the main body of the head-mounted display equipped with a pupillary-distance adjustment mechanism;

FIG. 4 is a diagram showing exemplary normal display check screens for display respectively on right and left display panels of the head-mounted display;

FIG. 5A is a diagram showing an exemplary normal display check screen to be looked at by a user under the normal circumstances;

FIG. 5B is a diagram showing another exemplary normal display check screen to be looked at by the user under the normal circumstances;

FIG. 5C is a diagram showing still another exemplary normal display check screen to be looked at by the user under the normal circumstances;

FIG. 6A is a diagram showing an exemplary normal display check screen to be looked at by the user under the not-normal circumstances;

FIG. 6B is a diagram showing another exemplary normal display check screen to be looked at by the user under the not-normal circumstances;

FIG. 6C is a diagram showing still another exemplary normal display check screen to be looked at by the user under the not-normal circumstances;

FIG. 7A is a diagram for illustrating a problem of the normal display check screen of FIG. 4;

FIG. 7B is a diagram for illustrating another problem of the normal display check screen of FIG. 4;

FIG. 8A is a diagram exemplarily showing how the normal display check screen looks with addition of enhancement sections each being a short lateral line to upper and lower ends of vertical lines;

FIG. 8B is another diagram exemplarily showing how the normal display check screen looks with addition of the enhancement sections each being a short lateral line to the upper and lower ends of the vertical lines;

FIG. 9A is a diagram exemplarily showing how the normal display check screen looks for the user in the normal state with addition of the enhancement sections each being a short lateral line to the upper and lower ends of the vertical lines;

FIG. 9B is another diagram exemplarily showing how the normal display check screen looks for the user in the normal state with addition of the enhancement sections each being a short lateral line to the upper and lower ends of the vertical lines;

FIG. 9C is still another diagram exemplarily showing how the normal display check screen looks for the user in the normal state with addition of the enhancement sections each being a short lateral line to the upper and lower ends of the vertical lines;

FIG. 10A is a diagram exemplarily showing how the normal display check screen looks for the user in the not-normal state with addition of the enhancement sections each being a short lateral line to the upper and lower ends of the vertical lines;

FIG. 10B is another diagram exemplarily showing how the normal display check screen looks for the user in the not-normal state with addition of the enhancement sections each being a short lateral line to the upper and lower ends of the vertical lines;

FIG. 10C is still another diagram exemplarily showing how the normal display check screen looks for the user in the not-normal state with addition of the enhancement sections each being a short lateral line to the upper and lower ends of the vertical lines; and

FIG. 11 is a diagram showing an exemplary startup screen available for use to adjust a pupillary distance.

### DETAILED DESCRIPTION OF EMBODIMENT

Hereinafter, an embodiment of the present disclosure will be described in detail with reference to the drawings.

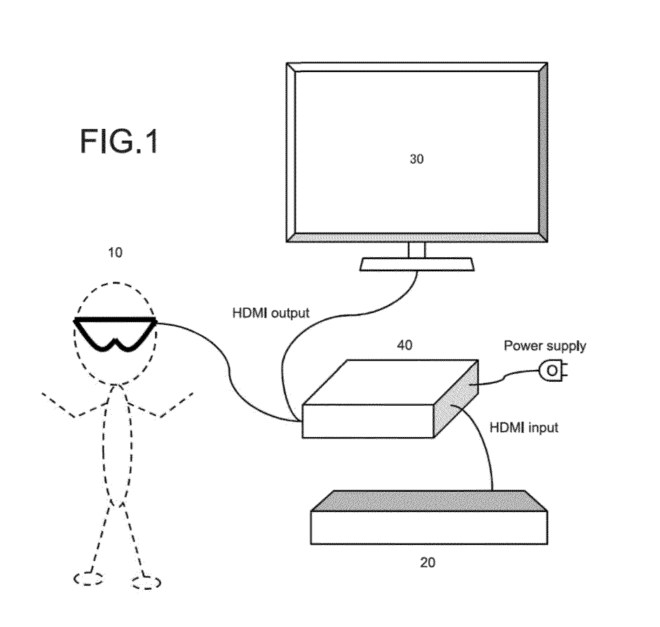

FIG. 1 schematically shows the configuration of an image display system including a head-mounted display. The system of FIG. 1 is configured to include the main body of a head-mounted display 10, a Blu-ray disc reproduction apparatus 20, a high-definition display (e.g., HDMI (High-Definition Multimedia Interface) television) 30, and a front-end box 40. The Blu-ray disc reproduction apparatus 20 reproduces Blu-ray discs being sources of viewing contents. The high-definition display 30 is also the output destination of the contents reproduced by the Blu-ray disc reproduction apparatus 20. The front-end box 40 processes an AV (Audio Visual) signal coming from the Blu-ray disc reproduction apparatus 20.

The front-end box 40 is equivalent to an HDMI repeater that processes the AV signal provided by the Blu-ray disc reproduction apparatus 20 over an HDMI cable, and outputs the resulting signal again over the HDMI cable, for example. The front-end box 40 is also a two-output switcher that directs the contents reproduced by the Blu-ray disc reproduction apparatus 20 to either the head-mounted display 10 or the high-definition display 30. In the example of FIG. 1, the front-end box 40 has two outputs, but may have three or more outputs. Herein, the front-end box 40 exclusively limits the output destinations of the AV signals, and gives the highest priority to the head-mounted display 10 for output.

Note that the HDMI is the interface standards intended for digital home appliances mainly for use of transmission of audio and video. The HDMI is based on DVI (Digital Visual Interface), and uses TMDS (Transition Minimized Differential Signaling) for a physical layer. This system is HDMI 1.4 compliant, for example.

An HDMI cable is used to connect between the Blu-ray disc reproduction apparatus 20 and the front-end box 40, and between the front-end box 40 and the high-definition display 30. The HDMI cable may be also used to connect between the front-end box 40 and the head-mounted display 10, but any other type of cable may be used for serial transfer of AV signals. In this example, the AV signals and power are supplied over a piece of cable connecting between the front-end box 40 and the head-mounted display 10, and also over this cable, the head-mounted display 10 is provided also with power for driving.

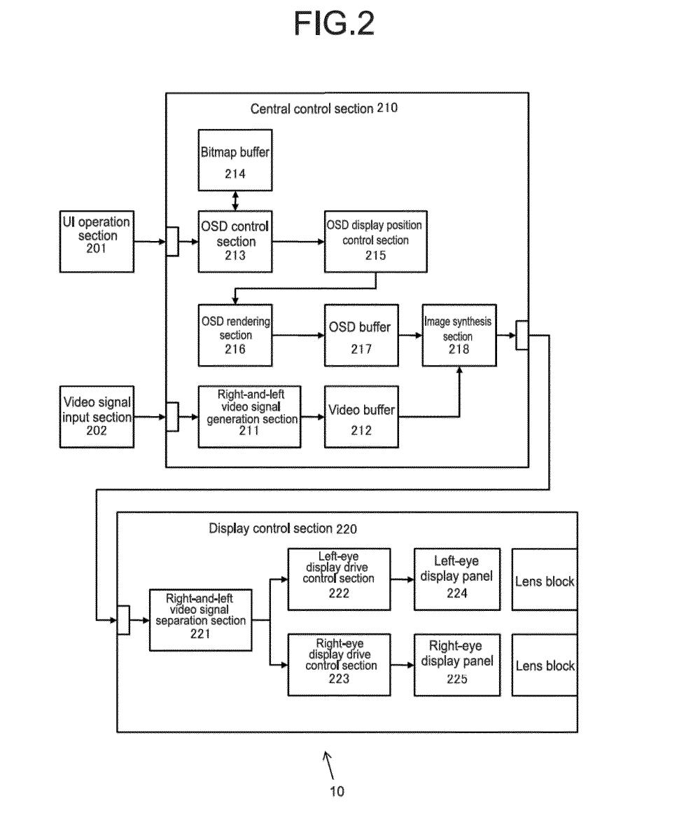

The head-mounted display 10 is provided with display sections respectively for right and left eyes. The display sections each include organic EL (Electro-Luminescent) elements, for example. The display sections for right and left eyes as such are each equipped with a low-distortion high-definition wide angle optical system. FIG. 2 schematically shows the internal configuration of the head-mounted display 10. The head-mounted display of FIG. 2 is configured to include a UI (User Interface) operation section 201, a video signal input section 202, a central control section 210, and a display control section 220.

The video signal input section 202 is provided with a video signal via the front-end box 40. The video signal is the one reproduced by and output from the Blu-ray disc reproduction apparatus 20.

In the central control section 210, a right-and-left video signal generation section 211 generates a right-and-left video signal from the provided video signal. This right-and-left video signal is a mixture of right and left-eye video signals. The right-and-left video signal generated as such is written to a video buffer 212. The central control section 210 is so configured as to generate a startup screen (will be described later) and a normal display check screen (will be described later) during startup of the head-mounted display 10, for example. The startup screen includes indications for use of pupillary-distance adjustment, and the normal display check screen is for use to check whether or not adjustment over the right and left screen positions is correctly made.

The UI operation section 201 accepts the user's operation made via buttons or others. In response to the UI operation, in the central control section 210, an OSD (Open Source Definition) control section 213 creates an OSD screen by reading image data of a corresponding menu from a bitmap buffer 214. An OSD display position control section 215 controls the display position of the OSD screen. An OSD rendering section 216 writes image data of the OSD screen to an OSD buffer 217 at the appropriate position. The OSD screen is a menu screen including a menu background region, and menu items.

An image synthesis section 218 superimposes the OSD screen written to the OSD buffer 217 on the image data written to the video buffer 212. The superimposed result is output to the display control section 220.

In the display control section 220, first of all, a right-and-left video signal separation section 221 splits the provided right-and-left video signal into the right-eye video signal and the left-eye video signal. A left-eye display drive control section 222 then exerts control over rendering of the left-eye video signal to a left-eye display panel 224. A right-eye display drive control section 223 exerts control over rendering of the right-eye video signal to a right-eye display panel 225. These left- and right-eye display panels 224 and 225 are each a display device of organic EL elements, liquid crystal elements, or the like. The left- and right-eye display panels 224 and 225 are each equipped with a lens block for image enlargement. These right and left lens blocks are each a combination of a plurality of optical lenses, and optically process video displayed on the display panels 224 and 225. The video displayed on the light-emitting surfaces of the display panels 224 and 225 is enlarged when passing through the lens blocks, thereby forming a large-sized virtual image on the user's eyes' retinas. As such, image fusion between the left-eye video and the right-eye video is allowed in the user's brain looking at the image.

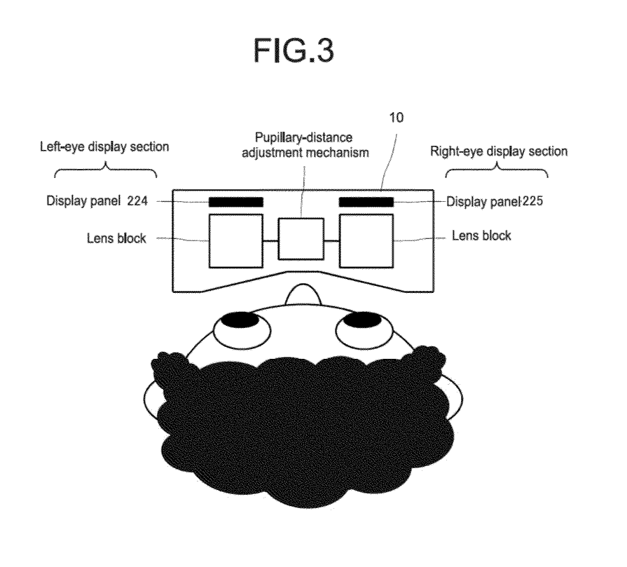

The head-mounted display 10 indeed has the optical systems separately for the right and left eyes of the user, but the optical systems are expected to be positioned with the user's eyes because the eye level and the pupillary distance vary among users. When the user views video reproduced by the Blu-ray disc reproduction apparatus 20 or others for a long period of time, for the sake of health of the eyes, precise positioning is desirable between images coming from the head-mounted display 10 and the user's pupillary distance. In consideration thereof, in this embodiment, the main body section of the head-mounted display 10 is equipped with a pupillary-distance adjustment mechanism between the right- and left-eye display sections for adjustment of the pupillary distance. FIG. 3 shows top view of the main body section of the head-mounted display 10 equipped with the pulillary-distance adjustment mechanism viewed from the above. Herein, how this pupillary-distance adjustment mechanism is implemented with which component is arbitrary. As an example, the head-mounted display 10 is provided with right and left slide switches for positional adjustment of the right and left display sections in the horizontal direction. By operating these right and left slide switches, the user is allowed to adjust the pupillary distance.

When the user views video reproduced by the Blu-ray disc reproduction apparatus 20 or others for a long period of time, for the sake of health of the eyes, precise positioning is desirable between images coming from the head-mounted display 10 and the user's pupillary distance. Also when the user views three-dimensional (3D) images using the head-mounted display 10, this easily causes eye strain because the 3D images affect the convergence angle of each eyeball and the focal length so that the pupillary-distance adjustment in this case is expected to be made specifically with a precision.

When the user wears and adjusts himself/herself the head-mounted display 10, the adjustment is made while the user is viewing images displayed on the right and left display sections. In this case, if a two-dimensional (2D) or 3D natural image is on the display sections, the user may have a difficulty in finding a prominent identifying feature, thereby resulting in a difficulty in making the pupillary-distance adjustment. In consideration thereof, for pupillary-distance adjustment by the user during startup of the head-mounted display 10, for example, the left and right display panels 224 and 225 desirably each output a display screen for use of the pupillary-distance adjustment.

The display screen for use of the pupillary-distance adjustment may display a simple geometric figure, e.g., a combination of figures in black and white. The left and right display panels 224 and 225 display the same pattern of figures at the same time (or the same pattern of figures but inverted in color at the same time). This indeed provides the user with a visually prominent identifying feature for the use of the pupillary-distance adjustment. As an example, see Specification of Japanese Patent Application Laid-open No. 2010-287835 already assigned to the applicant of the present disclosure. On the other hand, in this embodiment, the pupillary-distance adjustment is made not using such a screen specifically for the adjustment use but using a startup screen. Moreover, for the pupillary-distance adjustment, a character string of a predetermined size is displayed substantially at the center of the startup screen as an alternative to the simple geometric figure.

When such a character string is used for the pupillary-distance adjustment as an alternative to the simple geometric figure, the user is allowed to check in detail whether or not the positioning of the pupillary distance is correct only by looking at the character string because the character string includes circles, openings, and various types of lines such as vertical lines, lateral lines, and slanting lines. The displayed character string is not used only for the adjustment, but may be used also as a message for the user.

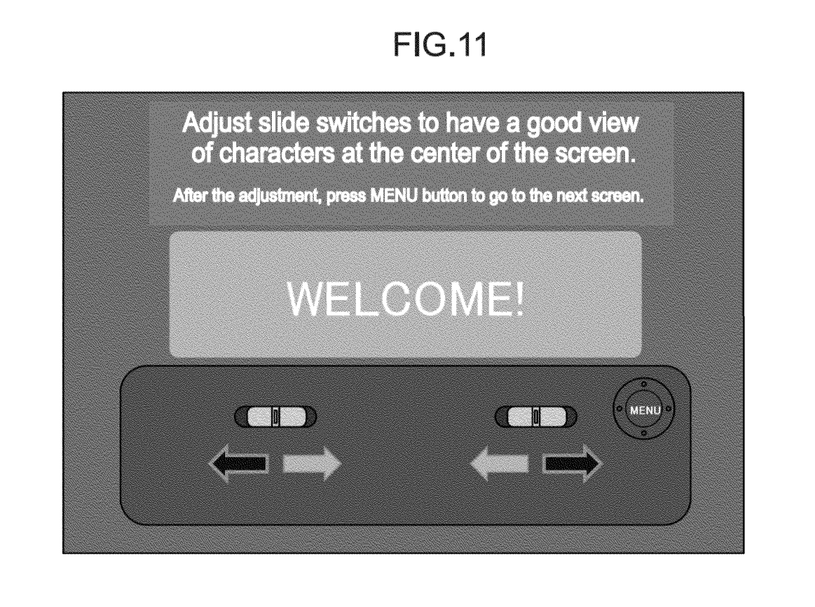

FIG. 11 shows an exemplary startup screen of the head-mounted display 10 also for use of the pupillary-distance adjustment. As to a message sentence of “WELCOME!” at the center of the screen, each character has circles, openings, and various types of lines such as vertical lines, lateral lines, and slanting lines. This visually gives the user the prominent identifying feature for the pupillary-distance adjustment. The upper portion of this startup screen also includes another message sentence of “Adjust slide switches to have a good view of characters at the screen center” to encourage the user to make the pupillary-distance adjustment by looking at the display of the message sentence of “WELCOME!”. The startup screen also includes a message sentence of “After the adjustment, press MENU button to go to the next screen” as instructions for the user after the pupillary-distance adjustment.

The head-mounted display 10 has right and left slide switches respectively for positional adjustment of the right and left display sections in the horizontal direction. The user operates these right and left slide switches to adjust the pupillary distance (in the manner as described above). The lower portion of the startup screen of FIG. 11 displays a picture of the right and left slide switches and therearound equipped to the main body of the head-mounted display 10, thereby giving an illustrated description how to make the pupillary-distance adjustment.

Before shipment of the head-mounted display 10, the manufacturer/distributor thereof generally adjusts the left and right display panels 224 and 225 in screen position to allow suitable image fusion between right and left video in the user's brain by virtual images being formed on the user's eyes' retinas with a desired angle of view and sense of depth. However, after the purchase by the user, the screen positions of the right and left display sections having been adjusted as such may be displaced on impact during the use. If the user keeps using the head-mounted display 10 for viewing of video with the left and right display panels 224 and 225 whose screen positions are not appropriate, the user's eyes may get tired easily, and may cause health damage.

In consideration thereof, in the embodiment, during every startup of the head-mounted display 10, a “normal display check screen” is displayed for the user to check whether the screen positions of the left and right display panels 224 and 225 are correct or not before the user's viewing of contents. By looking at this normal display check screen, if the user notices that the screen positions are not correctly adjusted, the user is expected to immediately stop using the head-mounted display 10, and make an inquiry to the manufacturer or ask them for a repair.

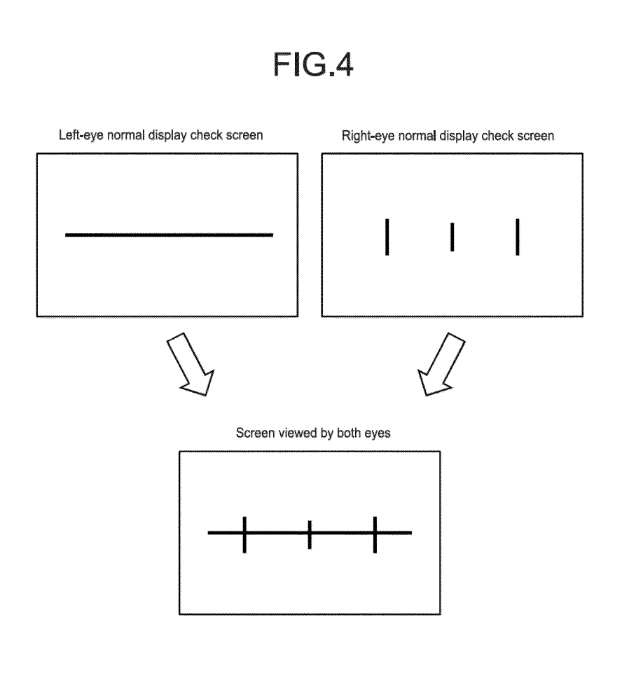

FIG. 4 shows an exemplary normal display check screen to be displayed on the left and right display panels 224 and 225 of the head-mounted display 10. The normal display check screen in the example of FIG. 4 is a combination of a left-eye normal display check screen, and a right-eye normal display check screen. The left-eye normal display check screen displays a long lateral line extending in the horizontal direction substantially at the center of the screen in the vertical direction. The right-eye normal display check screen displays short vertical lines aligned side by side substantially at the center of the screen in the vertical direction. The left-eye normal display check screen as such is displayed on the left display panel 224, and the right-eye normal display check screen as such is displayed on the right display panel 225. As a result, the right and left display screens are subjected to image fusion in the user's brain so that the user views such a pattern as shown in the lower portion of FIG. 4, i.e., a pattern in which a long lateral line goes across a plurality of short vertical lines.

Herein, the normal display check screen of FIG. 4 is assumed to display the lateral and vertical lines all in light gray in the background of dark gray, for example. The reason of using the low-contrast color scheme such as dark gray and light gray is that the high-contrast color scheme causes a difficulty in seeing boundary portions.

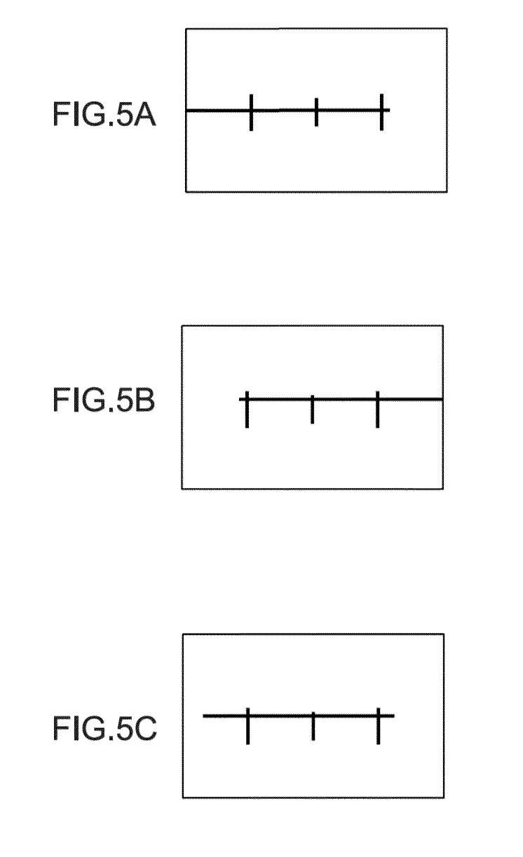

FIGS. 5A to 5C each show an exemplary normal display check screen to be looked at by the user in the normal circumstances. FIG. 5A shows a case that the lateral line on the left-eye normal display check screen is shifted in the horizontal direction. FIG. 5B shows a case that the lateral line on the left-eye normal display check screen is shifted in both the horizontal and vertical directions. FIG. 5C shows a case that the vertical lines on the right-eye normal display check screen are shifted in the horizontal or vertical direction. Even in the cases of FIGS. 5A, 5B, and 5C, as long as the user sees the long lateral line going across all of the short vertical lines on the screen, the user is allowed to determine that the screen positions of the left and right display panels 224 and 225 are correctly adjusted.

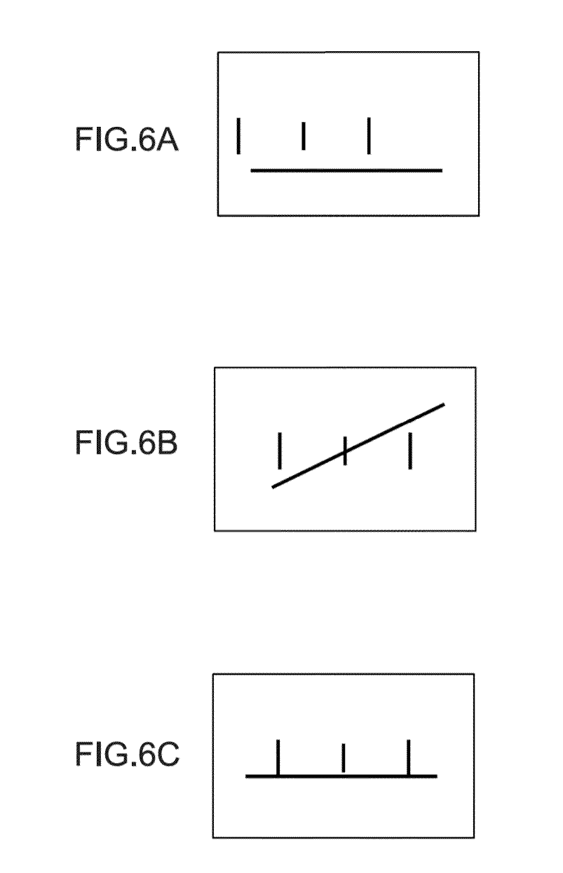

FIGS. 6A to 6C each show an exemplary normal display check screen to be looked at by the user in the not-normal circumstances. FIG. 6A shows a case that the lateral line on the left-eye normal display check screen does not entirely go across the vertical lines on the right-eye normal display check screen because the lateral line is shifted in the vertical direction to a considerable degree, and because the vertical lines are shifted in the horizontal direction. FIG. 6B shows a case that the lateral line on the left-eye normal display check screen does not go across at least a part of the vertical lines as is largely tilted. FIG. 6C shows a case that the lateral line on the left-eye normal display check screen does not go across at least a part of the vertical lines even if the shift thereof in the vertical direction is not that much. In these cases of FIGS. 6A to 6C, the screen positions are considered not correctly adjusted. As such, when noticing that the long lateral line does not go across at least a part of the vertical lines, the user is allowed to determine that the screen positions are not correctly adjusted.

Note that, as to the lateral line on the left-eye normal display check screen and the vertical lines on the right-eye normal display check screen, their lengths and positions are the design matters as long as the user is allowed to determine whether or not the screen positions are correctly adjusted by looking at the long lateral line going across all of the short vertical lines.

That is, the normal display check screen of FIG. 4 is a simple approach to allow the user, by being displayed on the left and right display panels 224 and 225 at the same time, to visually check the state of normal display depending on the lateral line going across all of the vertical lines after the image fusion in the user's brain.

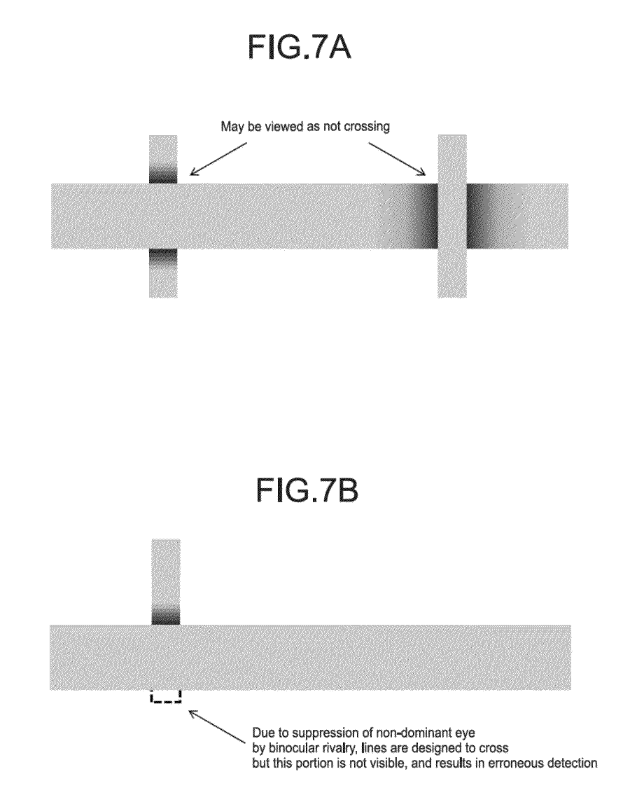

The concern here is that, as exemplarily shown in FIG. 7A, when the user looks at the right and left normal display check screens, the lateral and vertical lines do not look like crossing each other although they are overlaid one on the other, e.g., the lateral line looks like being in front of the vertical line, or the lateral line looks like being behind the vertical line. If this is the case, the user may erroneously determine that the state is not normal although the screen positions are correctly adjusted.

Moreover, as shown in FIGS. 5B and 5C, even if the relative positions of the lateral and vertical lines on the left- and right-eye normal display check screens are changed in the vertical direction, as long as these lines are crossing each other, the screen positions are determined to be correctly adjusted. However, there may be a case as shown in FIG. 7B, i.e., a part of the vertical line indicated by dotted lines is not visible although the vertical line is designed to go across the lateral line, and thus the user may erroneously determine that the state is not normal. This seems due to the suppression of a non-dominant eye by the binocular rivalry. Considering that it depends on the user which of the eyes is not dominant, the position change in advance for display may be difficult for the right- and left-eye normal display check screens.

As a possible approach to solve the problems of FIGS. 7A and 7B, the applicant of the present disclosure proposes to provide an enhancement section to each end of each vertical line on the right-eye normal display check screen for ease of viewing. This accordingly allows the user to determine the crossing between the horizontal and vertical lines with a higher precision and reliability by checking whether the lateral line goes across the portion between the enhancement sections at the upper and lower ends. With the enhancement sections provided as such at the upper and lower ends of the vertical lines, the user may easily use the enhancement sections as the prominent identifying features. This thus reduces the possibility of erroneous detection of end portions due to the suppression of the non-dominant eye by the binocular rivalry.

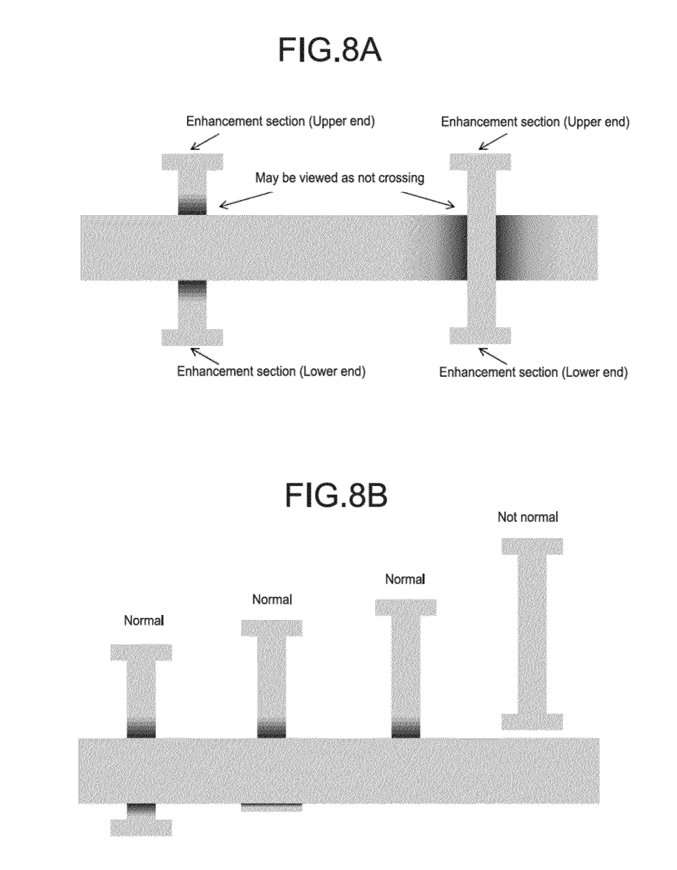

As exemplary enhancement sections to be provided to the upper and lower ends of the vertical line, the enhancement sections may be each a short lateral line to shape the vertical line as an alphabetic letter of “I” (see FIGS. 8A to 10C). As another example, the enhancement section may be changed in color to look conspicuous (not shown).

FIGS. 8A and 8B each show an exemplary normal display check screen with enhancement sections in the former example, i.e., the enhancement sections are each a short lateral line, and are provided to the upper and lower ends of a vertical line. As shown in FIG. 8A, when the user looks at the right and left normal display check screens, the lateral and vertical lines do not look like crossing each other although they are overlaid one on the other, e.g., the lateral line looks like being in front of the vertical line, or the lateral line looks like being behind the vertical line. Even if this is the case, the user is allowed to determine with a precision that the lateral and vertical lines are crossing each other because the lateral line goes through the portion between the enhancement sections at the upper and lower ends of the vertical line. This thus reduces the possibility of the user's erroneous determination that the state is not normal.

Moreover, as shown in FIGS. 5B and 5C, even if the relative positions of the lateral and vertical lines on the left- and right-eye normal display check screens are changed in the vertical direction, the user finds it easy to check whether or not the vertical lines are away from the lateral line because the upper and lower ends of the vertical line are enhanced by the short lines provided as described above. As an example, in FIG. 8B, as to the three vertical lines from the left, their enhancement sections at the lower end portions are not away from the upper end of the lateral line, and the user thus finds it easy to check their crossing. On the other hand, as to the vertical line at the right end, the user easily sees that the enhancement section at the lower end is away from the upper end of the lateral line, thereby easily determining that the screen positions are not correctly adjusted.

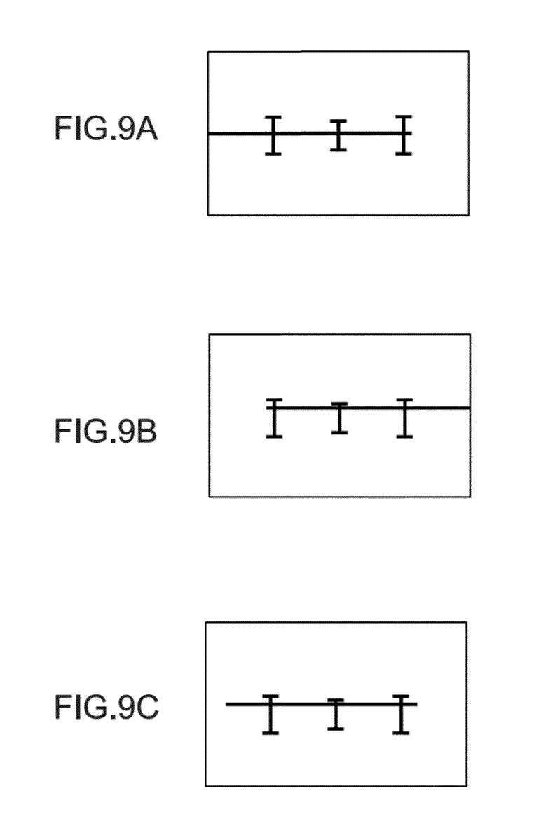

FIGS. 9A to 9C each show an exemplary normal display check screen to be looked at by the user in the normal circumstances when the enhancement section being a short lateral line is provided to the upper and lower ends of each of the vertical lines. FIG. 9A shows a case that the lateral line on the left-eye normal display check screen is shifted in the horizontal direction. FIG. 9B shows a case that the lateral line on the left-eye normal display check screen is shifted in both the horizontal and vertical directions. FIG. 9C shows a case that the vertical lines on the right-eye normal display check screen are shifted in the horizontal or vertical direction. Even in the cases of FIGS. 9A, 9B, and 9C, as long as the user sees the long lateral line going across all of the short vertical lines on the screen, the user is allowed to determine that the screen positions of the left and right display panels 224 and 225 are correctly adjusted. With the enhancement sections provided to the upper and lower ends of each of the vertical lines as such, the user may make a visual check with a higher precision.

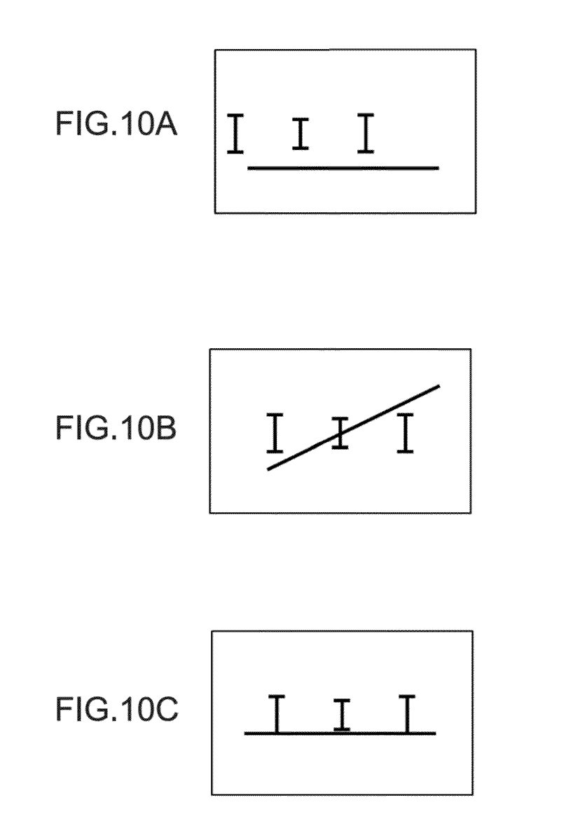

FIGS. 10A to 10C each show an exemplary normal display check screen to be looked at by the user in the not-normal circumstances when the enhancement section being a short lateral line is provided to the upper and lower ends of each of the vertical lines. FIG. 10A shows a case that the lateral line on the left-eye normal display check screen do not go across all of the vertical lines because the lateral line is shifted in the vertical direction to a considerable degree. FIG. 10B shows a case that the lateral line on the left-eye normal display check screen does not go across all of the vertical lines because the lateral line is tilted and is not horizontal any more. FIG. 10C shows a case that the lateral line does not go across all of the vertical lines on the right-eye normal display check screen because the vertical lines are shifted in the vertical direction to a considerable degree. In these cases of FIG. 10A, 10B, and 10C, the screen positions are considered not correctly adjusted. As such, when noticing that the long lateral line does not go across at least a part of the vertical lines, the user may determine that the screen positions are not correctly adjusted. With the enhancement sections provided to the upper and lower ends of each of the vertical lines, the user may make a visual check with a higher precision.

The present disclosure may also take the following structures.

(1) A head-mounted display, including:
a left-eye display section configured to display a left-eye image;
a right-eye display section configured to display a right-eye image; and
a display control section configured to exert control over screen display of the right- and left-eye display sections, in which
for checking whether or not adjustment over screen positions of the right- and left-eye display sections is correctly made, the display control section displays a combination of a first normal display check screen and a second normal display check screen by the right- and left-eye display sections, the first normal display check screen including a lateral line extending in a horizontal direction at a screen center, the second normal display check screen including a plurality of short vertical lines aligned in the horizontal direction at the screen center, and the display control section provides an enhancement section to each of upper and lower ends of each of the vertical lines on the second normal display check screen.

(2) The head-mounted display according to (1), in which
the enhancement section is a short lateral line to be rendered at each of the upper and lower ends of each of the vertical lines on the second normal display check screen.

(3) The head-mounted display according to (1) in which
at startup of the head-mounted display, the display control section displays the combination of the first and second normal display check screens by the right- and left-eye display sections.

(4) The head-mounted display according to (1), further including:
a pupillary-distance adjustment mechanism configured to adjust a pupillary distance between the right- and left-eye display sections, wherein
for adjustment of the pupillary distance by the pupillary-distance adjustment mechanism, the display control section displays a pupillary-distance adjustment screen by the right- and left-eye display sections, the pupillary-distance adjustment screen including a character string substantially at the screen center.

(5) The head-mounted display according to (1), further including:
a pupillary-distance adjustment mechanism configured to adjust a pupillary distance between the right- and left-eye display sections, in which
at startup of the head-mounted display, the display control section displays a startup screen by the right- and left-eye display sections, the startup screen including a character string substantially at the screen center for use of adjustment of the pupillary distance by the pupillary-distance adjustment mechanism.

(6) A display control method for a head-mounted display, including:
displaying, for checking whether or not adjustment over a screen position of the head-mounted display is correctly made, a combination of a first normal display check screen and a second normal display check screen by a right-eye display section and a left-eye display section, the first normal display check screen including a lateral line extending in a horizontal direction at a screen center, the second normal display check screen including a plurality of short vertical lines aligned in the horizontal direction at the screen center, in which
in the displaying, an enhancement section is provided to each of upper and lower ends of each of the vertical lines on the second normal display check screen.

(7) The display control method for the head-mounted display according to (6), in which
in the displaying, the enhancement section being a short lateral line is rendered at each of the upper and lower ends of each of the vertical lines on the second normal display check screen.

(8) The display control method for the head-mounted display according to (6), in which
in the displaying, at startup of the head-mounted display, the combination of the first and second normal display check screens are displayed on the right- and left-eye display sections.

(9) The display control method for the head-mounted display according to (6), in which the head-mounted display further includes
a pupillary-distance adjustment mechanism configured to adjust a pupillary distance between the right- and left-eye display sections,
the display control method further including:
   displaying, for adjustment of the pupillary distance by the pupillary-distance adjustment mechanism, a pupillary-distance adjustment screen by the right- and left-eye display sections, the pupillary-distance adjustment screen including a character string substantially at the screen center.

(10) The display control method for the head-mounted display according to (6), in which the head-mounted display further includes
a pupillary-distance adjustment mechanism configured to adjust a pupillary distance between the right- and left-eye display sections,
the display control method further including:
   displaying, at startup of the head-mounted display, a startup screen by the right- and left-eye display sections, the startup screen including a character string substantially at the screen center for use of adjustment of the pupillary distance by the pupillary-distance adjustment mechanism.

While the present disclosure has been described in detail, the foregoing description is in all aspects illustrative and not restrictive. It is understood that numerous other modifications and variations are to be devised without departing from the scope of the present disclosure.

In this specification, mainly described is the embodiment of applying the present disclosure to the head-mounted display, but the scope of the present disclosure is surely not restricted to the configuration of any specific head-mounted display. The present disclosure is applicable also to various types of display systems, e.g., display systems of displaying right-eye video, left-eye video, or a plurality of video pieces at the same time.

That is, the present disclosure is described by way of examples, and the description of this specification shall not be restrictively interpreted. In order to determine the scope of the present disclosure in this specification, claims shall be taken into consideration.

It should be understood by those skilled in the art that various modifications, combinations, sub-combinations and alterations may occur depending on design requirements and other factors insofar as they are within the scope of the appended claims or the equivalents thereof.

What is claimed is:

1. A head-mounted display, comprising:
a left-eye display section configured to display a left-eye image;
a right-eye display section configured to display a right-eye image; and
a display control section configured to exert control over screen display of the right- and left-eye display sections, the display control section being further configured to display, for checking whether or not adjustment over screen positions of the right- and left-eye display sections is correctly made, a combination of a first normal display check screen and a second normal display check screen by the right- and left-eye display sections, the first normal display check screen including a lateral line extending in a horizontal direction at a screen center, the second normal display check screen including a plurality of short vertical lines aligned in the horizontal direction at the screen center, and the display control section providing an enhancement section to each of upper and lower ends of each of the vertical lines on the second normal display check screen.

2. The head-mounted display according to claim 1, wherein
the enhancement section is a short lateral line to be rendered at each of the upper and lower ends of each of the vertical lines on the second normal display check screen.

3. The head-mounted display according to claim 1, wherein
at startup of the head-mounted display, the display control section displays the combination of the first and second normal display check screens by the right- and left-eye display sections.

4. The head-mounted display according to claim 1, further comprising:
a pupillary-distance adjustment mechanism configured to adjust a pupillary distance between the right- and left-eye display sections, wherein
for adjustment of the pupillary distance by the pupillary-distance adjustment mechanism, the display control section displays a pupillary-distance adjustment screen by the right- and left-eye display sections, the pupillary-distance adjustment screen including a character string substantially at the screen center.

5. The head-mounted display according to claim 1, further comprising:
a pupillary-distance adjustment mechanism configured to adjust a pupillary distance between the right- and left-eye display sections, wherein
at startup of the head-mounted display, the display control section displays a startup screen by the right- and left-eye display sections, the startup screen including a character string substantially at the screen center for use of adjustment of the pupillary distance by the pupillary-distance adjustment mechanism.

6. A display control method for a head-mounted display, comprising:
displaying, for checking whether or not adjustment over a screen position of the head-mounted display is correctly made, a combination of a first normal display check screen and a second normal display check screen by a right-eye display section and a left-eye display section, the first normal display check screen including a lateral line extending in a horizontal direction at a screen center, the second normal display check screen including a plurality of short vertical lines aligned in the horizontal direction at the screen center,
in the displaying, an enhancement section being provided to each of upper and lower ends of each of the vertical lines on the second normal display check screen.

7. The display control method for the head-mounted display according to claim 6, wherein
in the displaying, the enhancement section being a short lateral line is rendered at each of the upper and lower ends of each of the vertical lines on the second normal display check screen.

8. The display control method for the head-mounted display according to claim 6, wherein
in the displaying, at startup of the head-mounted display, the combination of the first and second normal display check screens are displayed on the right- and left-eye display sections.

9. The display control method for the head-mounted display according to claim 6, wherein
the head-mounted display further includes a pupillary-distance adjustment mechanism configured to adjust a pupillary distance between the right- and left-eye display sections,
the display control method further comprising:
displaying, for adjustment of the pupillary distance by the pupillary-distance adjustment mechanism, a pupillary-distance adjustment screen by the right- and left-eye display sections, the pupillary-distance adjustment screen including a character string substantially at the screen center.

10. The display control method for the head-mounted display according to claim 6, wherein
the head-mounted display further includes a pupillary-distance adjustment mechanism configured to adjust a pupillary distance between the right- and left-eye display sections,
the display control method further comprising:
displaying, at startup of the head-mounted display, a startup screen by the right- and left-eye display sections, the startup screen including a character string substantially at the screen center for use of adjustment of the pupillary distance by the pupillary-distance adjustment mechanism.
